(19) United States
(12) Patent Application Publication
(10) Pub. No.: US 2016/0360852 A1
(43) Pub. Date: Dec. 15, 2016

(54) MUSICAL COMB

(71) Applicant: Dean H. HERING, Raleigh, NC (US)

(72) Inventor: Dean H. HERING, Raleigh, NC (US)

(21) Appl. No.: 14/737,976

(22) Filed: Jun. 12, 2015

(51) Int. Cl. A45D 24/02; G10D 17/00

(52) U.S. Cl. CPC A45D 24/02; G10D 17/00

(57) ABSTRACT

A personal grooming device a body defining a grasping surface defining an outer portion and an inner portion, as well as groups of members extending directly from the inner portion at varying depth so that the members are capable of playing a musical note or notes.

### BACKGROUND

1. Field

The following description relates to personal grooming devices intended to achieve dual functions, namely those of personal grooming as well as relay of information such as music.

2. Description of Related Art

When providing such a grooming device, like that of a hair comb, it is desirable and necessary to preserve aspects that define the identity of the device as a comb and facilitate the combing function. For instance, some of these aspects may include teeth having ends that are collinear, so as to be aligned along a same row, and wherein the teeth are substantially evenly spaced relative to each other and connected to a handle. Each of these aspects enables grasping of hair at a desired depth so as to permit the comb to sweep evenly through hair without becoming stuck, as may occur with clumped hair sometimes occasioned by excess water in the hair or uneven drying thereof.

Thus far, past designs attempting the aforementioned dual functions of personal grooming and music relay have varied. Such variation has particularly included separate attachment of the teeth to the handle so as to allow for possible displacement of one or more teeth while combing or attempting to play music, as well as teeth that must calibrated to a certain depth within the comb, resulting in extreme height differences between neighboring teeth which inevitably disallow even passage through hair at a certain depth. Yet further variation has included a sharply inclined base yielding teeth that are substantially smaller in size at one end of the comb than at another end whereby the similar drawback of uneven combing exists.

Accordingly, it is desirable to provide a personal grooming device such as a comb capable of preserving the identity and functionality thereof, while also enabling the effective playing of music.

### SUMMARY

In one general aspect, there is provided a personal grooming device, the device including a body comprising a grasping surface defining an outer portion and an inner portion thereof, and groups of members extending directly from the inner portion at varying depth, and configured to each play a musical note.

An aspect thereof may include a respective group of members that is configured to play a musical note, wherein the musical note is selected from the group consisting of a same musical note and a different musical note with respect to an adjacent, respective group of members.

Another aspect thereof may include respective groups of members that are separated by a gap therebetween such that a member does not extend from the inner portion at the gap.

Another aspect thereof may include a distance that respective groups of members extend from the inner portion being defined as a same distance or a different distance.

Another aspect thereof may include the distance being a different distance.

In another general aspect, there is provided a personal grooming device, the device including a body, and groupings of members extending from the body and being separated by a gap therebetween in which a length of the gap corresponds to spacing between musical notes which the groupings of members are configured to play, respectively.

An aspect thereof may include a number of the members within a respective group corresponding to a duration that a note is to be played.

An aspect of the another general aspect may include lengths of members of the groupings corresponding to frequencies of the musical notes.

An aspect thereof may include lengths of members of a respective grouping being the same.

An aspect thereof may include lengths of successively adjacent groupings of members being based on a frequency corresponding to a length of members of a preceding group thereof.

An aspect of the another general aspect in which lengths of members of the groupings correspond to frequencies of the musical notes may include variation in the lengths of the members from the body corresponding to a variation of depth of a body surface from which the members extend.

Another aspect thereof may include the body surface being an inner surface opposite an outer surface of the body which is configured to be grasped by a user.

Another aspect thereof may include terminal portions of the members being collinear.

Another aspect thereof may include the body being expansible.

An aspect of the another general aspect may include the body being expansible.

In yet another general aspect, there is provided a musical comb, the musical comb including a base including a peak and a valley, and teeth of equal height positioned throughout the valley of the base, wherein some of the teeth are equally spaced apart and at least one tooth of the teeth is unequally spaced apart from the other teeth.

An aspect thereof may include teeth of equal height positioned throughout a peak of the base, wherein some of the teeth are equally spaced apart and at least one tooth of the teeth is unequally spaced apart from the other teeth.

An aspect thereof may include the teeth positioned throughout the valley and the peak being respectively unequally spaced from each other by a gap therebetween.

An aspect thereof may include the teeth positioned throughout the valley and the peak being adjacent, and separated by a gap therebetween.

Other features and aspects may be apparent from the following detailed description, the drawings and the claims.

### BRIEF DESCRIPTION OF THE DRAWINGS

FIG. 1 is a front and side elevational view illustrating an example of a personal grooming device accomplishing dual functions, and namely personal grooming as well as relay of information such as music.

FIG. 2 is a front perspective view of the personal grooming device of FIG. 1.

FIG. 3 is a front perspective view of the personal grooming device of FIG. 1 illustrating a manner of playing music.

FIG. 4A is an example illustration of correspondence between the personal grooming device of FIG. 1 and a song to be played using the device.

FIG. 4B is an example chart diagram corresponding to FIG. 4A.

FIG. 5 is a front perspective view of the personal grooming device of FIG. 1 illustrating expansability thereof.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

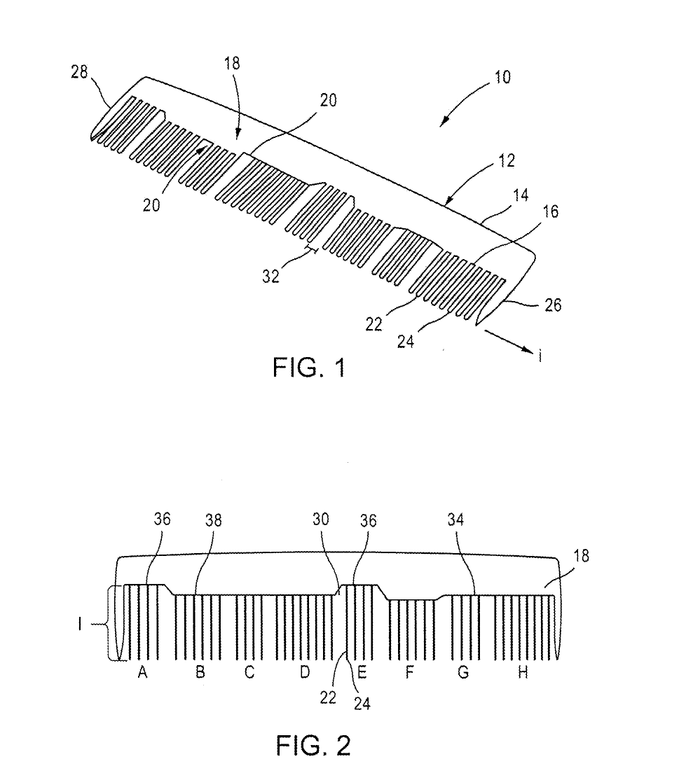

FIG. 1 illustrates an example of a personal grooming device 10 accomplishing dual functions, and namely personal grooming as well as relay of information such as music.

As shown therein, the device 10 is optionally formed as a comb and includes a body 12 defining an outer portion 14 and an inner portion 16 providing a grasping surface 18 therebetween which a user may grasp, as a handle, when using the device 10 to either comb hair or play music. The inner portion 16 provides a base 20 from which members such as comb teeth 22 directly extend. As is also shown, the teeth 22 are aligned at their terminal portions 24 distal to their direct connection to the base 20 so as to be collinear. That is, the terminal portions 24 extend along a row, and more particularly, touch an imaginary line “i” connecting opposing ends 26, 28 of outer portion 14.

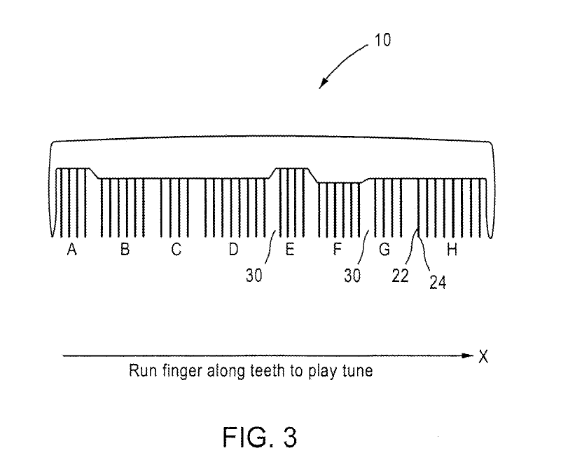

As will be appreciated from the illustrated arrangement of teeth 22 shown in FIGS. 1 and 2, such teeth 22 are arranged in groups A-H, whereby the groups A-H of teeth 22 each enable playing of a musical note upon movement of the teeth 22 of a particular group, as discussed hereinafter. Each of the teeth 22 belonging to groups A-H are, as shown, equally spaced from each other and contemplated to be of a height or length “1” corresponding to a relative frequency of a note to be played upon movement of teeth 22 within a particular group of teeth 22. Separating each of the shown groups A-H of teeth 22 are gaps 30 which enable a user of the device 10 to play a particular note in isolation by plucking only a particular group A-H of teeth 22. The gaps 30 also permit a user time to hear, and thus perceive, separation between notes of music which describe a particular tune or song. In other words, the gaps 30 enable a user to have pause and transition period from one note to a successive note to be played. Accordingly, it will be understood that the spaced length 32 of the gap 30 is a function of the spacing between the musical notes to be played and may be determined arbitrarily in accordance with the length of device 10.

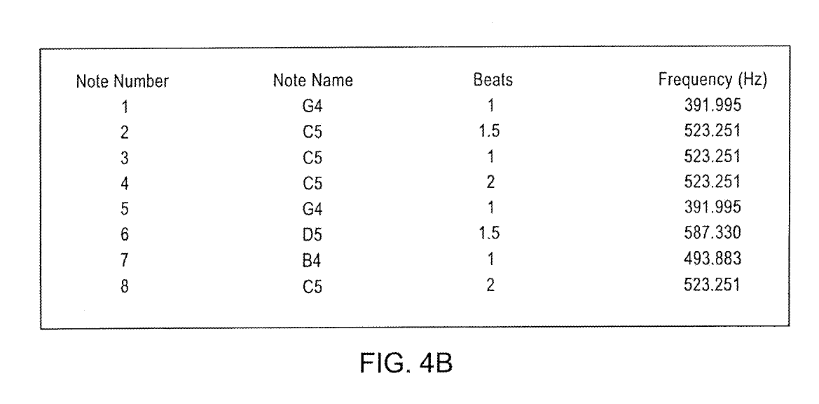

As shown with reference to FIGS. 2, 4A and 4B, the length “1” of teeth 22 of each of the groups of teeth 22 determines the relative frequency for a given musical note, as discussed below. Thus, in order to preserve the combing function and identity of the device 10 as a comb whereby the terminal portions 24 of teeth 22 are collinear, the base 20 from which the teeth extend is provided with a variable contour 34. This contour 34 provides, optionally, a variable depth of the grasping surface 18 so as to define peaks 36 and valleys 38 of the base 20 relative to the terminal portions 24 of the teeth 22. Thus, lengths “1” of teeth 22 of a given group of teeth 22 may be optionally sized so as to be distanced from the contour 34 according to their required, relative frequency by tailoring the contour 34 of the base 20 to accommodate the aforementioned collinearity.

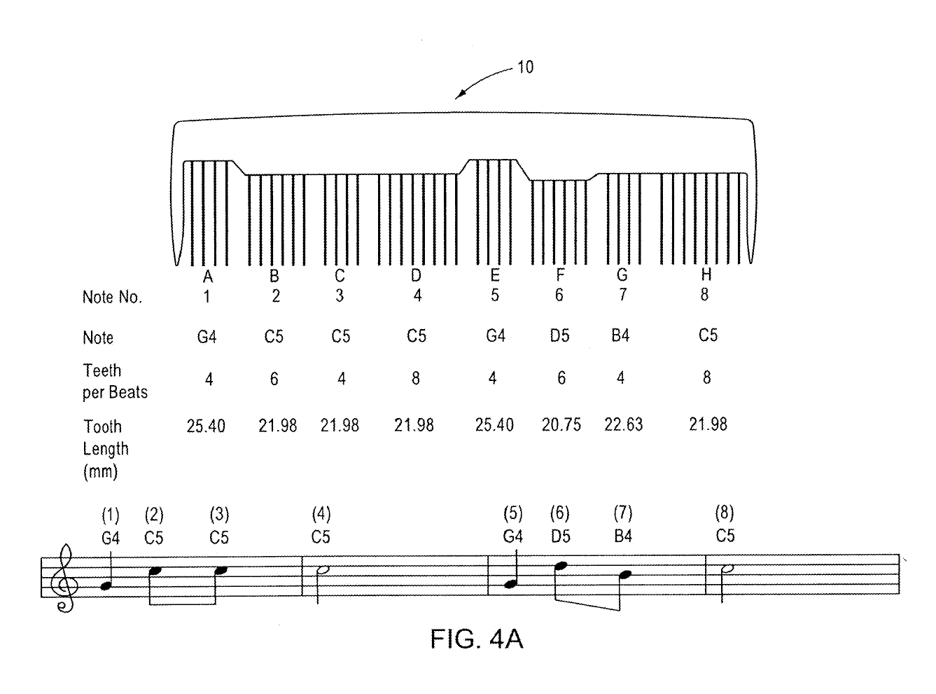

With further reference to FIG. 2, each group A-H of teeth 22 is shown to include several teeth 22, though it is contemplated that a group of teeth may, as an example, have a single tooth 22. As such, when playing the device 10 to relay a desired tune or song, the tooth 22, a group of teeth 22 or all of the groups A-H of teeth 22 may be played by plucking the teeth 22. As an example, a user of the device 10 may simply play the musical notes of the groups A-H by moving his or her finger along the terminal portions 24 of the teeth 22 in the direction of arrow X, as shown in FIG. 3. When doing so, it is contemplated that the user will appreciate a familiarity of a played note corresponding to a group of teeth 22 due to the gaps 30 between groups A-H of teeth 22. The duration of a given note corresponding to a particular group of teeth 22 corresponds to the number of teeth 22 within a grouping thereof so as to define the duration in musical beats, as discussed below.

Frequency and Duration

To recognize a tune, the human ear does not need to hear the exact frequency and duration of notes. Rather, perception of the relative frequencies and durations of notes of a tune or song is the essential component for recognizing a familiarity of a reproduction of the tune or song. Maintenance of these relative frequencies and durations enable the music to be scaled to different “keys.”

Referring again to FIG. 2, frequency of a particular note is, as discussed, determined by a length “1” of teeth 22 for a particular group thereof. As also discussed, relative frequencies between notes must be maintained, such that for a first note, a ratio of a known, corresponding frequency, fₙ, and thus a known, predetermined length, Lₙ, to a successive frequency, f₊₁, must be maintained; whereby a length “1” of teeth 22 for the corresponding, successively adjacent group of teeth 22 necessary to play its corresponding note may be calculated in accordance with Equation (1) below, assuming a tooth 22 of the device 10 represents a cantilevered beam and f₁ and f₂ represent examples of successively adjacent frequencies.

$${f}_{1} / {f}_{2} = ( {ω}_{1} / 2 π ) / ( {ω}_{2} / 2 π ) = {ω}_{1} / {ω}_{2} = \frac{\sqrt{EI / {m}_{1} {L}_{1}^{4}}}{\sqrt{EI / {m}_{2} {L}_{2}^{4}}} , \qquad Equation ( 1 )$$

where frequency (f) measured in (Hz) is related to circular frequency by f=ω/2π (where ω is the circular natural frequency given by 1.875² (EI/mL⁴)^{1/2}, E is the modulus of rigidity of the tooth material, m is the mass of the tooth, I is the moment of inertia of the tooth cross-section, and L is the length of the tooth. As will be understood, the differences in masses relative to the lengths to the fourth power may be considered to be negligible such that the masses may be considered to be the same.
Thus, with the above ratio of relative frequencies, the equation to obtain successive lengths of teeth 22 for groups of teeth 22 along the device 10 may be reduced to Equation (2), shown below.

L₂=L₁\sqrt{f₂/f₁} Equation (2):

With their relative lengths being determined in accordance with the above, a duration of each of the notes respectively assigned to the groups A-H of teeth 22 is determined, optionally, in accordance with a predetermined number of teeth 22 corresponding to a beat, which will be understood, is a measure of the aforementioned duration. For instance, if a given note is intended to last a duration of two (2) beats, and a beat is predetermined to be represented by four (4) teeth, the number of teeth 22 corresponding to the two (2) beat duration is eight (8) teeth.

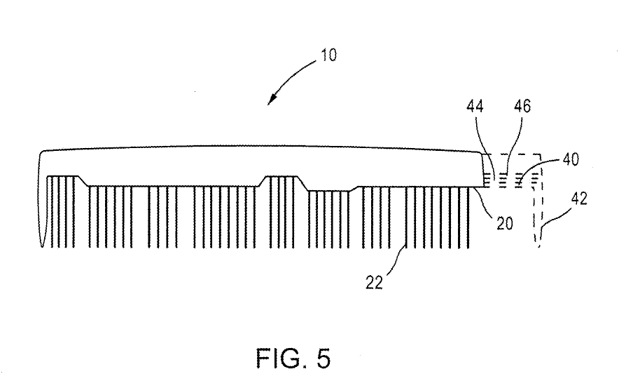

In view of the above, it is thus further contemplated that, as illustrated in FIG. 5, the device 10 may, optionally, be expansible whereby at least one of outer portion ends 26, 28 is removed to accommodate a further base portion 40 (having teeth 22 thereof omitted for clarity of illustration). As shown, base portion 40 includes a further outer end portion 42 and adjoins base portion 20 along overlapping guide rails 44, 46 fixedly connected therebetween in any known manner such as by soldering, screw-attachment or gluing. As such, whether the device 10 is expansible or not, it is further contemplated that a musical chord may optionally be played.

As an example, the device 10 as described hereinabove may be made in accordance with methods such as 3D printing and injection molding. As another example, the device 10 herein may made using any method producing the same in finished form from metal, plastic or any hybrid of metal and plastic.

A working example of the personal grooming device is illustrated in FIGS. 4A and 4B. Therein, a tune from the well-known wedding song, “Here Comes the Bride,” is illustrated along with a representative selection of sheet music having the indicated, “Note No.,” indicated parenthetically thereat. Correspondence between the device 10 and the tune is shown so as to relate assignment of particular notes to groups A-H of teeth 22, together with their respective frequencies as determined by the length of teeth 22 within those groups A-H. More specifically, with the quarter note, G4, as reference Note 1 having a standard frequency of 391.995 Hz and duration of 1 beat corresponding to four (4) teeth, and each group A-H of teeth 22 assigned a respective note number, successive lengths of teeth 22 for successively adjacent notes may be calculated in accordance with the frequency of the preceding note in the tune. Furthermore, since, as shown, four (4) teeth were predetermined to carry the duration of one (1) beat of Note 1, musical Note four (4), in contrast and corresponding to half note C5, with a duration of two (2) beats, is shown as being assigned eight (8) teeth.

A number of examples have been described above. Nevertheless, it will be understood that various modifications may be made. For example, suitable results may be achieved if the described techniques are performed by a different calculation and/or if components in a described device are combined in a different manner and/or replaced or supplemented by other components or their equivalents. Accordingly, other implementations are within the scope of the following claims.

1. A personal grooming device, comprising:
a body comprising a grasping surface defining an outer portion and an inner portion thereof; and
groups of individual members extending from the inner portion, wherein individual members in each group comprise a same height corresponding to a respective musical note and are equally spaced by a distance, each group comprises a number of individual members corresponding to a number of beats the respective musical note is to last, terminal portions of all individual members are collinear, and
the groups of individual members are respectively separated by gaps of differing distance, to produce pauses between adjacent respective musical notes.

2. The personal grooming device of claim 1, wherein:
the respective musical note played by each of the groups of individual members is a same musical note or a different musical note with respect to an adjacent group of individual members.

3. The personal grooming device of claim 2, wherein:
each of the gaps is free of any member.

4. The personal grooming device of claim 3, wherein:
a distance that respective groups of individual members extend from the inner portion is a same distance or a different distance.

5. The personal grooming device of claim 4, wherein:
the distance is the different distance.

6. A personal grooming device, comprising:
a body; and
within the body, groups of individual teeth each extending from the body, wherein individual teeth of a respective group are of a same height corresponding to a respective musical note, the individual teeth of a respective group are equally spaced by a distance and terminal portions of all of the individual teeth are collinear, the groups being respectively separated by gaps, differing from the distance, therebetween
a number of individual teeth in each group of individual teeth corresponds to a number of beats the respective musical note is to last, and
a size of the gaps varies to produce pauses and transitions between respective musical notes.

7. (canceled)

8. The personal grooming device of claim 6, wherein:
lengths of the teeth correspond to frequencies of the respective musical notes.

9. (canceled)

10. The personal grooming device of claim 8, wherein:
lengths of the teeth of successively adjacent groups of teeth are based on a frequency corresponding to a length of members of a preceding group of teeth.

11. The personal grooming device of claim 8, wherein:
variation in the lengths of the teeth corresponds to a variation of depth of a body surface from which the teeth extend.

12. The personal grooming device of claim 11, wherein:
the body surface is an inner surface opposite an outer surface of the body configured to be grasped by a user.

13. (canceled)

14. The personal grooming device of claim 1, wherein:
the body is expansible.

15. The personal grooming device of claim 6, wherein:
the body is expansible.

16. A musical comb, comprising:
a base comprising a peak region and a valley region; and
first individual teeth of equal height and positioned throughout the valley region of the base, wherein
the first individual teeth are formed as groups, each group comprising a plurality of first individual teeth such that each group of first individual teeth corresponds to a respective musical beats the respective musical note is to last, wherein terminal portions of all of the teeth are collinear, and
the first individual teeth of each group are equally spaced apart by a distance and at least one of the groups of first individual teeth is unequally spaced apart from the first individual teeth in another group of first individual teeth by a gap of another distance.

17. The musical comb of claim 16, further comprising:
second individual teeth of equal height and positioned throughout a peak of the base region, wherein
the second individual teeth are formed as groups, each group comprising a plurality of second individual teeth such that each group of second individual teeth corresponds to a respective musical note and each group comprises a number of individual teeth corresponding to a number of beats the respective musical note is to last, and
the second individual teeth are equally spaced apart and at least one of the groups of second individual teeth is unequally spaced apart from the second individual teeth in another group of second individual teeth by a gap of another distance.

18. The musical comb of claim 17, wherein:
the first and second individual teeth are respectively positioned throughout the valley region and the peak region so as to be unequally spaced from each other by a gap therebetween to produce pauses and transitions between respective musical notes corresponding to the first and second individual teeth.

19. (canceled)

20. The personal grooming device of claim 1, wherein all members are of equal thickness.

21. The personal grooming device of claim 6, wherein all teeth are of equal thickness.

22. The musical comb of claim 15, wherein all teeth are of equal thickness.
